(19) United States
(12) Patent Application Publication
(10) Pub. No.: US 2016/0341169 A1
(43) Pub. Date: Nov. 24, 2016

(54) REVERSIBLE STARTER MOTOR

(71) Applicant: Schaeffler Technologies AG & Co. KG, Herzogenaurach (DE)

(72) Inventor: Larry Haines, Coshocton, OH (US)

(21) Appl. No.: 14/717,682

(22) Filed: May 20, 2015

(51) Int. Cl. F02N 15/02; F02N 11/08

(52) U.S. Cl. CPC F02N 15/022; F02N 11/0859

(57) ABSTRACT

A starter including: a housing; a motor shaft located within the housing; an electric motor located within the housing and arranged to rotate the motor shaft in first and second opposite circumferential directions about an axis of rotation; an output shaft non-rotatably connected to the motor shaft; and a one-way clutch including first and second races. The first race includes a pinion gear fixed with respect to axial movement, parallel to the axis of rotation, with respect to the housing and arranged to mesh with a ring gear. The second race is non-rotatably connected to the output shaft. For a start mode, the electric motor is arranged to rotate the motor shaft and the pinion gear in a first circumferential direction.

### TECHNICAL FIELD

The present disclosure relates to a starter for an internal combustion engine. In particular, to a starter with a reversible motor and a one-way clutch to enable the starter to remain engaged with a ring gear.

### BACKGROUND

Known starter motors include a retractable pinion gear disengageable from a flywheel of a combustion engine after a starting sequence. The engagement and disengagement of the pinion gear can cause damage to respective gear teeth on the pinion gear and flywheel and also places a high current load on the starter motor, which can lead to premature failure of the rotor and brushes. Further, the pinion gear and the ring gear may clash if the ring gear is rotating when the pinion gear is engaged with the ring gear.

### SUMMARY

According to aspects illustrated herein, there is provided a starter including: a housing; a motor shaft located within the housing; an electric motor located within the housing and arranged to rotate the shaft in first and second opposite circumferential directions about an axis of rotation; an output shaft non-rotatably connected to the motor shaft; and a one-way clutch including first and second races. The first race includes a pinion gear fixed with respect to axial movement, parallel to the axis of rotation, with respect to the housing and arranged to mesh with a ring gear. The second race is non-rotatably connected to the output shaft. For a start mode, the electric motor is arranged to rotate the motor shaft and the pinion gear in a first circumferential direction.

According to aspects illustrated herein, there is provided a starter including: a housing; a motor shaft located within the housing; an electric motor located within the housing arranged to rotate the motor shaft in first and second opposite circumferential directions about an axis of rotation; an output shaft non-rotatably connected to the motor shaft; and a one-way clutch including a first race including a pinion gear fixed with respect to axial movement, parallel to the axis of rotation, with respect to the housing and arranged to mesh with a ring gear, and a second race non-rotatably connected to the output shaft. For a start mode the electric motor is arranged to rotate the motor shaft in the first circumferential direction and the one-way clutch is arranged to non-rotatably connect the motor shaft and the pinion gear. For a release mode: the electric motor is arranged to rotate the shaft in the second circumferential direction; and the pinion gear is arranged to rotate in the second circumferential direction; or the motor shaft is arranged to rotate with respect to the pinion gear in the second circumferential direction.

According to aspects illustrated herein, there is provided a starter, including a housing; a motor shaft located within the housing; an electric motor located within the housing arranged to rotate the motor shaft in first and second opposite circumferential directions about an axis of rotation; an output shaft; a sun gear non-rotatably connected to the motor shaft; a planetary carrier formed from a portion of the output shaft; a ring gear grounded to the housing; a plurality of planet gears meshed with the sun and ring gears and connected to the planetary carrier; and a one-way clutch including a first race including a pinion gear fixed with respect to axial movement, parallel to the axis of rotation, with respect to the housing and arranged to mesh with a ring gear, and a second race non-rotatably connected to the output shaft. For a start mode, the electric motor is arranged to rotate the motor shaft in the first circumferential direction and the one-way clutch is arranged to non-rotatably connect the motor shaft and the pinion gear. For a release mode: the electric motor is arranged to rotate the shaft in the second circumferential direction; and the pinion gear is arranged to rotate in the second circumferential direction or the motor shaft is arranged to rotate with respect to the pinion gear in the second circumferential direction.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a perspective view of a cylindrical coordinate system demonstrating spatial terminology used in the present application;

FIG. 2 is a perspective view of a starter with an axially fixed pinion gear;

FIG. 3 is a side view of the starter in FIG. 2;

FIG. 4 is a cross-sectional view of the starter taken generally along line 4-4 in FIG. 2;

FIG. 5 is a schematic view of a control circuit for the starter in FIG. 2;

FIG. 6 is a cross-sectional view of the starter taken generally along line 6-6 in FIG. 3.

### DETAILED DESCRIPTION

At the outset, it should be appreciated that like drawing numbers on different drawing views identify identical, or functionally similar, structural elements of the disclosure. It is to be understood that the disclosure as claimed is not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It should be understood that any methods, devices or materials similar or equivalent to those described herein can be used in the practice or testing of the disclosure.

By “non-rotatably connected” first and second components we mean that the first component is connected to the second component so that any time the first component rotates, the second component rotates with the first component, and any time the second component rotates, the first component rotates with the second component. Axial displacement between the first and second components is possible. It is not necessary for the first and second components to rotate at the same rate.

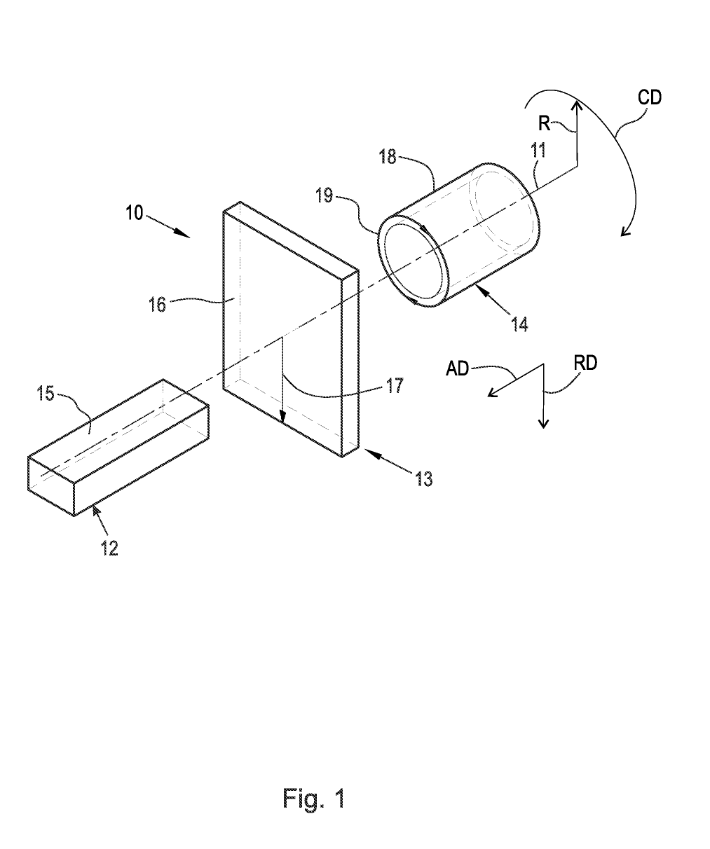

FIG. 1 is a perspective view of cylindrical coordinate system 10 demonstrating spatial terminology used in the present application. The present application is at least partially described within the context of a cylindrical coordinate system. System 10 includes longitudinal axis 11, used as the reference for the directional and spatial terms that follow. Axial direction AD is parallel to axis 11. Radial direction RD is orthogonal to axis 11. Circumferential direction CD is defined by an endpoint of radius R (orthogonal to axis 11) rotated about axis 11.

To clarify the spatial terminology, objects 12, 13, and 14 are used. An axial surface, such as surface 15 of object 12, is formed by a plane parallel to axis 11. Axis 11 is coplanar with planar surface 15; however it is not necessary for an axial surface to be coplanar with axis 11. A radial surface, such as surface 16 of object 13, is formed by a plane orthogonal to axis 11 and coplanar with a radius, for example, radius 17. Surface 18 of object 14 forms a circumferential, or cylindrical, surface. For example, circumference 19 forms a circle on surface 18. As a further example, axial movement is parallel to axis 11, radial movement is orthogonal to axis 11, and circumferential movement is parallel to circumference 19. Rotational movement is with respect to axis 11. The adverbs “axially,” “radially,” and “circumferentially” refer to orientations parallel to axis 11, radius 17, and circumference 19, respectively.

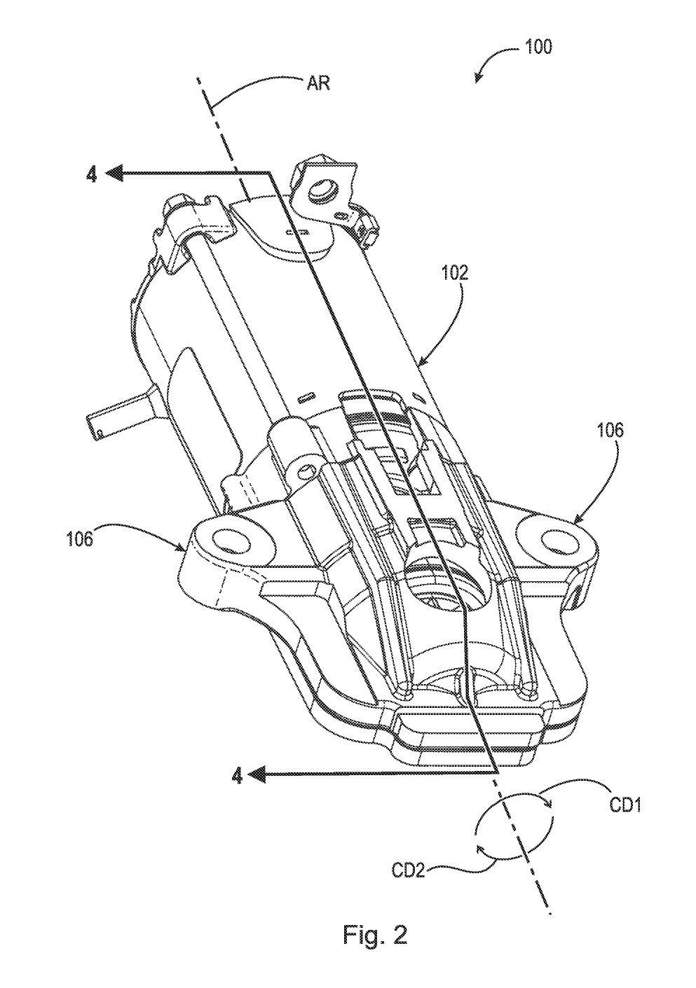

FIG. 2 is a perspective view of starter 100 with an axially fixed pinion gear.

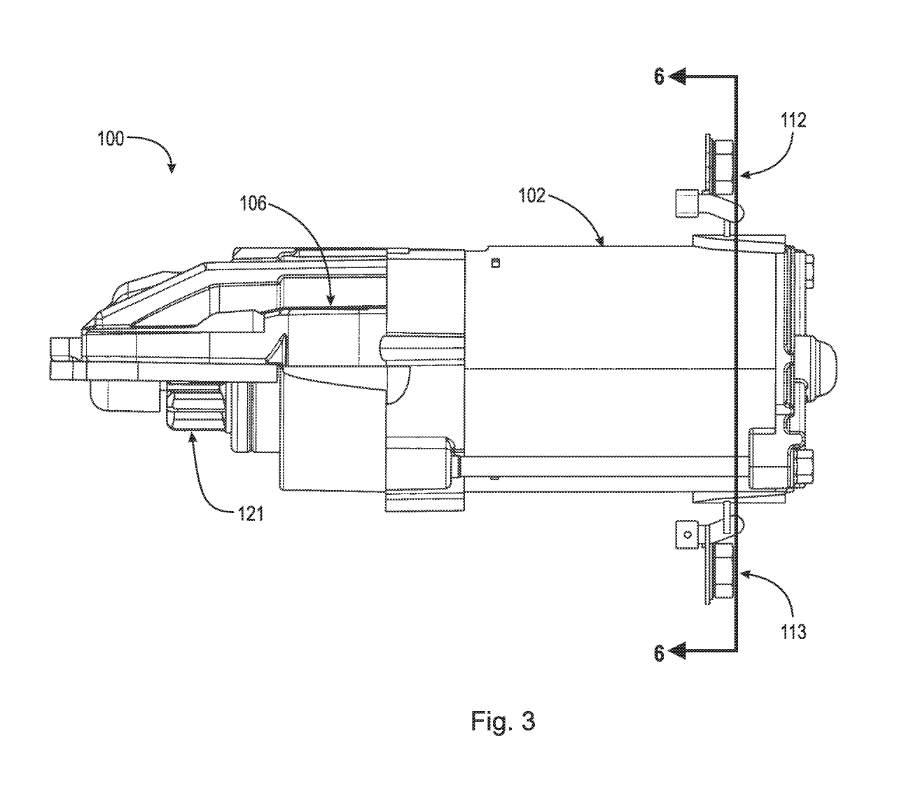

FIG. 3 is a side view of starter 100 in FIG. 2.

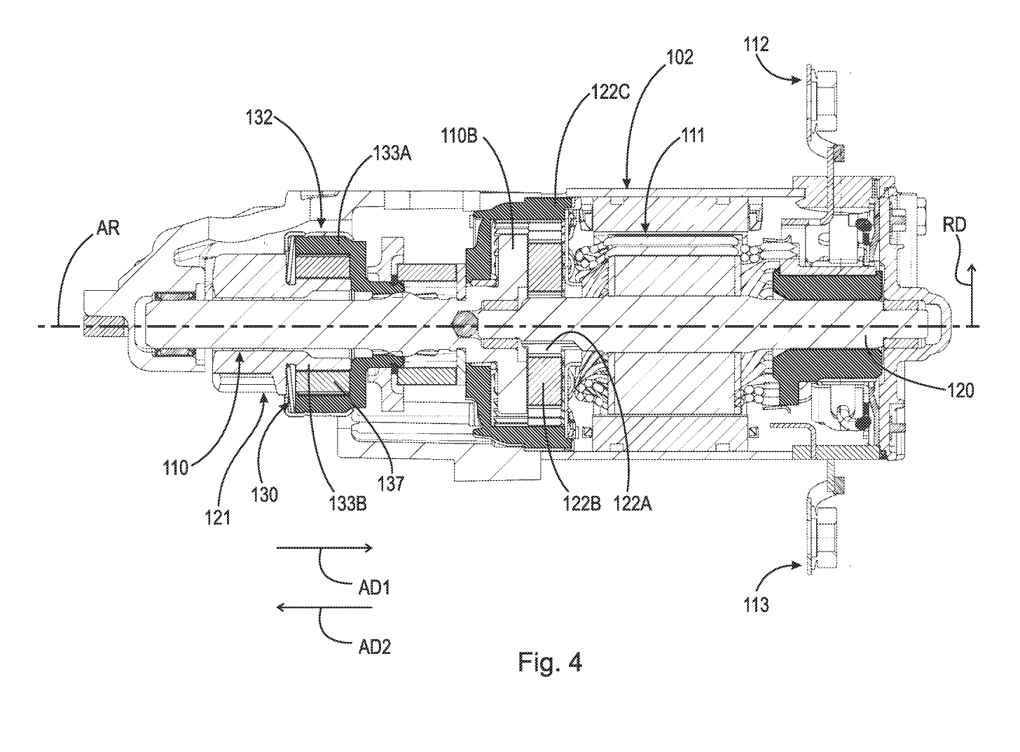

FIG. 4 is a cross-sectional view of starter 100 taken generally along line 4-4 in FIG. 2. The following should be viewed in light of FIGS. 2 through 4. Starter 100 includes housing 102, motor shaft 120 located within housing 102, electric motor 111 located within housing 102, and output shaft 110. Motor 111 is arranged to rotate motor shaft 120 in opposite circumferential directions CD1 and CD2 about axis of rotation AR. Starter 100 includes one-way clutch 132 with races 133A and 133B. Race 133A is non-rotatably connected to output shaft 110. Race 133B includes pinion gear 121. Gear 121 is arranged to mesh with a ring gear for a starting assembly (not shown) for an internal combustion engine (not shown). Pinion gear 121 is fixed, with respect to movement in opposite axial directions AD1 and AD2, parallel to axis AR, with respect to housing 102. For a start mode, motor 111 is arranged to rotate shaft 120 and gear 121 in direction CD1. In an example embodiment, output shaft 110 is fixed with respect to housing 102, in directions AD1 and AD2.

In an example embodiment, starter 100 includes: sun gear 122A fixed to shaft 120, planetary carrier 110B formed by output shaft 110, planet gears 122B which rotate on shafts extending from planet carrier 110B, and ring gear 122C non-rotatably connected, or grounded, to housing 102. Planet gears 122B are meshed with the sun gear and ring gear 122C. By two or more components “non-rotatably connected” we mean that whenever any one of the components rotates, the other components rotate as well. That is, the components are fixed to each other with respect to rotation.

For the start mode, race 133A is arranged to non-rotatably connect to race 133B. For a release mode, in which the starting cycle for the internal combustion engine is complete, electric motor 111 is arranged to rotate motor shaft 120 in circumferential direction CD2 and as further described below, pinion gear 121 is arranged, in a first phase, to rotate in circumferential direction CD2, and, in a second phase, race 133A is arranged to rotate, with respect to race 133B and pinion gear 121, in circumferential direction CD2. In the second phase, rotation of the pinion gear in direction CD2 is blocked.

One-way clutch 132 includes resilient element 130 directly engaged with races 133A and 133B. Element 130 can be in direct contact with races 133A and 133B or can be in direct contact with respective components non-rotatably connected to races 133A and 133B. Resilient element 130 reacts against race 133B to apply a frictional force to race 133A, or resilient element 130 reacts against race 133A to apply a frictional force to race 133B. For the first phase of the release mode, the frictional force is greater than a force resisting rotation of gear 121 in direction CD2. Thus, resilient element 130 is arranged to frictionally connect races 133A and 133B and gear 121 is arranged to rotate with motor shaft 120 in circumferential direction CD2. That is, resilient element 130 is connected to races 133A and 133B by respective frictional connections.

The frictional connections can be non-rotatable connections or there can be slip between resilient element 130 and one or both of races 133A and 133B. For example: motor 111 rotates race 133A, in direction CD2, at a first speed and race 133B rotates at the first speed as well (non-rotatable connection of element 130 with races 133A and 133B); or, motor 111 rotates race 133A, in direction CD2, at a first speed and the slip/respective frictional connections result in element 130 rotating race 133B, but at a lower speed than the first speed (slip between resilient element 130 and one or both of races 133A and 133B). The slip can be between element 130 and one or both of races 133A and 133B. For example: resilient element 130 can be non-rotatably connected to race 133A and slip with respect to race 133B; resilient element 130 can be non-rotatably connected to race 133B and slip with respect to race 133A; or resilient element 130 can slip with respect to both races 133A and 133B.

In an example embodiment, element 130 is a diaphragm spring with an inner circumference engaged with race 133B and an outer circumference engaged with race 133A. In an example embodiment, element 130 is in contact with a component non-rotatably connected to race 133A and/or with a component non-rotatably connected to race 133B. In an example embodiment (not shown), element 130 includes: an inner circumference engaged with race 133A; and an outer circumference engaged with race 133B.

For the second phase, pinion gear 121 is arranged to resist, with a second force, greater than the first force, rotation in circumferential direction CD2 and race 133A and motor shaft 120 are arranged to rotate in circumferential direction CD2 with respect to race 133B and gear 121.

In an example embodiment, at least a portion of race 133A is located outward of race 133B in direction RD orthogonal to axis of rotation AR. In an example embodiment, one-way clutch 132 is a trapped roller clutch including cylindrical rolling elements 137 radially disposed between races 133A and 133B.

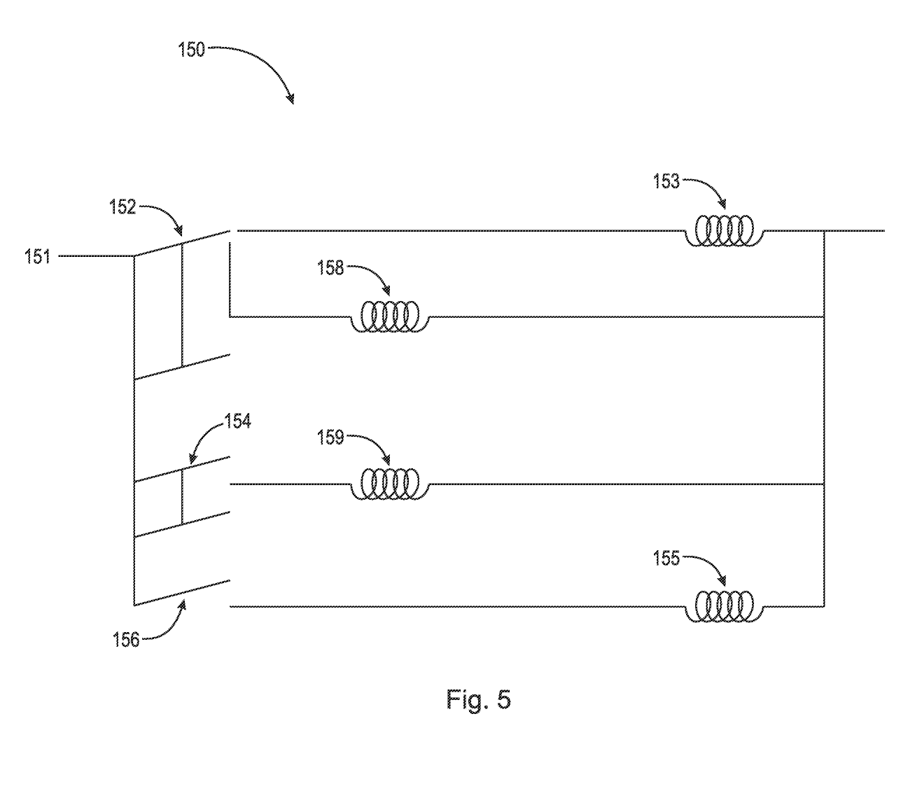

FIG. 5 is a schematic view of a control circuit for the starter in FIG. 2. Starter 100 includes a control circuit, for example, control circuit 150, configured to supply power to electric motor 111 to rotate motor shaft 120 in circumferential direction CD1 for the start mode, or in circumferential direction CD2 for the release mode. In an example embodiment, control circuit 150 includes battery power feed 151, starter relay switch 152, on delay timer 153, off delay timer switch 154, off delay timer 155, on delay timer switch 156, forward solenoid 158, and reverse solenoid 159.

In an example embodiment, for the start mode, control circuit 150 is configured to close switch 152 to: initiate a first time interval by triggering timer 153; and supply power to solenoid 158 to rotate motor shaft 120 in direction CD1. In an example embodiment, for the release mode, control circuit 150 is configured to close switches 154 and 156, upon expiration of the first time interval to. Switch 154 supplies power to solenoid 159 to rotate motor shaft 120 in circumferential direction CD2. Switch 156 initiates a second time interval by triggering timer 155. Upon expiration of the second time interval: circuit 150 is arranged to open switch 154 to turn off power to electric motor 111 and open switch 156.

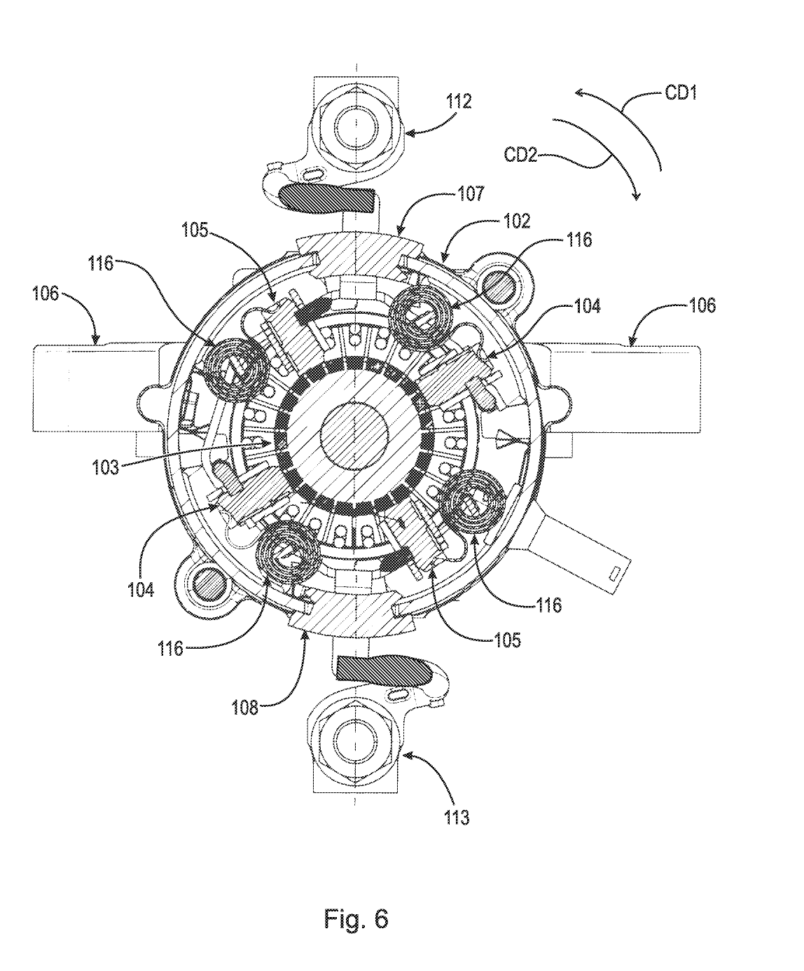

FIG. 6 is a cross-sectional view of starter 100 taken generally along line 6-6 in FIG. 3. In an example embodiment, electric motor 111 includes armature 103 and brushes 104 and 105. To enable rotation of motor 111 in directions CD1 and CD2, normally grounded brushes 104 are electrically isolated from housing 102. Motor 111 includes separate leads 107 and 108 for brushes 104 and 105, respectively, and mounts 112 and 113 for leads 107 and 108, respectively. Springs 116 maintain contact between armature 103 and brushes 104 and 105.

Starter 100 includes mounts, for example mounts 106, which enable starter 100 to be mounted to the bell housing of a transmission (not shown) or on an engine block (not shown).

Advantageously, starter 100 eliminates the problem noted above with respect to an axially displaceable pinion for a starter engaging with and disengaging from a ring gear. Specifically, output shaft 110 remains engaged with a ring gear at all times, not just during a starting sequence.

In an example embodiment, rotation of gear 121 in direction CD1 winds a wrap spring (not shown) engaged with a torque converter cover (not shown). For the first phase of the release mode, rotation of gear 121 in direction CD2 unwinds the wrap spring. The wrap spring does not resist rotation of output shaft 110 in direction CD2 with a force greater than the frictional force non-rotatably connecting resilient element 130 with races 133A and 133B. For the second phase of the release mode, the wrap spring is fully unwound and essentially acts as a stop for rotation of the pinion gear in direction CD2. The stop action of the wrap spring resists rotation of gear 121 in direction CD2 with a force greater than the frictional force non-rotatably connecting resilient element 130 with races 133A and 133B. As a result, clutch 132 slips and shafts 110 and 120 and race 133A are able to rotate with respect to the pinion gear to prevent damage to motor 111.

It should be understood that directions CD1 and CD2 can be reversed from the orientation shown in the figures.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A starter, comprising:
a housing;
a motor shaft located within the housing;
an electric motor located within the housing and arranged to rotate the motor shaft in first and second opposite circumferential directions about an axis of rotation;
an output shaft non-rotatably connected to the motor shaft; and,
a one-way clutch including:
a first race including a pinion gear, the pinion gear:
fixed with respect to axial movement, parallel to the axis of rotation, with respect to the housing; and,
arranged to mesh with a ring gear; and,
a second race non-rotatably connected to the output shaft, wherein for a start mode, the electric motor is arranged to rotate the motor shaft and the pinion gear in the first circumferential direction.

2. The starter of claim 1, wherein:
for the start mode, the first race is arranged to non-rotatably connect to the second race; and,
for a release mode:
the electric motor is arranged to rotate the motor shaft in the second circumferential direction; and,
the pinion gear is arranged to rotate in the second circumferential direction; or,
the second race is arranged to rotate, with respect to the first race, in the second circumferential direction.

3. The starter of claim 2, wherein:
for a first phase of the release mode, the pinion gear is arranged to rotate in the second circumferential direction; and,
for a second phase of the release mode, the second race is arranged to rotate with respect to the pinion gear in the second circumferential direction.

4. The starter of claim 3, wherein the one-way clutch includes a resilient element:
directly engaged with the first and second races; and,
reacting against the second race to apply a frictional force to the first race; or,
reacting against the first race to apply a frictional force to the second race.

5. The starter of claim 4, wherein for the first phase of the release mode, the resilient element is connected to the first and second races with respective frictional connections.

6. The starter of claim 5, wherein:
for the first phase of the release mode, the electric motor is arranged to rotate the second race, in the second circumferential direction, at a first speed; and,
the respective frictional connections are arranged to:
rotate the first race, in the second circumferential direction, at a second speed less than the first speed; or,
rotate the first race, in the second circumferential direction, at the first speed.

7. The starter of claim 4, wherein:
for the first phase of the release mode, the frictional force is arranged to connect the first and second races with a first force; and,
for the second phase of the release mode, the pinion gear is arranged to resist, with a second force greater than the first force, rotation in the second circumferential direction.

8. The starter of claim 3, wherein for the second phase of the release mode, rotation of the pinion gear in the second circumferential direction is arranged to be blocked.

9. The starter of claim 1, wherein the one-way clutch includes a plurality of rolling elements radially disposed between the first and second races.

10. A starter, comprising:
a housing;
a motor shaft located within the housing;
an electric motor located within the housing and arranged to rotate the motor shaft in first and second opposite circumferential directions about an axis of rotation;
an output shaft non-rotatably connected to the motor shaft; and,
a one-way clutch including:
a first race including a pinion gear, the pinion gear:
fixed with respect to axial movement, parallel to the axis of rotation, with respect to the housing; and,
arranged to mesh with a ring gear; and,
a second race non-rotatably connected to the output shaft, wherein:
for a start mode:
the electric motor is arranged to rotate the motor shaft in the first circumferential direction; and,
the one-way clutch is arranged to non-rotatably connect the motor shaft and the pinion gear; and,
for a release mode:
the electric motor is arranged to rotate the motor shaft in the second circumferential direction; and,
the pinion gear is arranged to rotate in the second circumferential direction; or,
the motor shaft is arranged to rotate, with respect to the pinion gear, in the second circumferential direction.

11. The starter of claim 10, wherein:
for a first phase of the release mode, the pinion gear is arranged to rotate in the second circumferential direction; and,
for a second phase of the release mode, the motor shaft is arranged to rotate, with respect to the pinion gear, in the second circumferential direction.

12. The starter of claim 11, wherein the one-way clutch includes a resilient element:
directly engaged with the first and second races; and,
reacting against the second race to apply a frictional force to the first race; or,
reacting against the first race to apply a frictional force to the second race.

13. The starter of claim 12, wherein:
for the first phase of the release mode:
the frictional force is arranged to non-rotatably connect the first and second races with a first force;
the pinion gear is arranged to resist, with a second force, rotation in the second circumferential direction; and,
the second force is insufficient to overcome the first force and cause rotation between the first and second races; and,
for the second phase of the release mode:
the pinion gear is arranged to resist, with a third force, rotation in the second circumferential direction; and,
the third force is sufficient to overcome the first force and cause the second race to rotate with respect to the first race.

14. The starter of claim 12, wherein:
the resilient element is a diaphragm spring with:
an inner circumference frictionally connected to the first race; and,
an outer circumference frictionally connected to the second race; and,
for the first phase of the release mode:
the electric motor is arranged to rotate the second race, in the second circumferential direction, at a first speed; and,
the frictional connections between the diaphragm spring and the first and second races are arranged to:
cause slip between the resilient element and one or both of the first and second races, such that the first race rotates, in the second circumferential direction, at a second speed less than the first speed; or,
rotate the first race, in the second circumferential direction, at the first speed.

15. The starter of claim 10, further comprising:
a control circuit configured to:
for the start mode:
supply power to the electric motor to rotate the motor shaft in the first circumferential direction; and,
initiate a first time interval; and,
for the release mode and upon expiration of the first time interval, supply power to the electric motor to rotate the motor shaft in the second circumferential direction.

16. The starter of claim 15, wherein the control circuit is configured to:
upon the expiration of the first time interval, initiate a second time interval; and,
upon expiration of the second time interval, turn off power to the electric motor.

17. A starter, comprising:
a housing;
a motor shaft located within the housing;
an electric motor located within the housing and arranged to rotate the motor shaft in first and second opposite circumferential directions about an axis of rotation;
an output shaft;
a sun gear non-rotatably connected to the motor shaft;
a planetary carrier formed from a portion of the output shaft;
a first ring gear non-rotatably connected to the housing;
a plurality of planet gears meshed with the sun and ring gears and connected to the planetary carrier; and,
a one-way clutch including:
a first race including a pinion gear, the pinion gear:
fixed with respect to axial movement, parallel to the axis of rotation, with respect to the housing; and,
arranged to mesh with a second ring gear; and,
a second race non-rotatably connected to the output shaft, wherein:
for a start mode:
the electric motor is arranged to rotate the motor shaft in the first circumferential direction; and,
the one-way clutch is arranged to non-rotatably connect the motor shaft and the pinion gear; and,
for a release mode:
the electric motor is arranged to rotate the shaft in the second circumferential direction; and,
the pinion gear is arranged to rotate in the second circumferential direction; or,
the motor shaft is arranged to rotate, with respect to the pinion gear, in the second circumferential direction.

18. The starter of claim 17, wherein:
for a first phase of the release mode, the pinion gear is arranged to rotate in the second circumferential direction; and,
for a second phase of the release mode, the second race is arranged to rotate, with respect to the pinion gear, in the second circumferential direction.

19. The starter of claim 18, wherein the one-way clutch includes a resilient element:
directly engaged with the first and second races; and,
reacting against the second race to apply a frictional force to the first race; or,
reacting against the first race to apply a frictional force to the second race.

20. The starter of claim 19, wherein for the first phase of the release mode:
the resilient element is connected to the first and second races with respective frictional connections;
the electric motor is arranged to rotate the second race, in the second circumferential direction, at a first speed; and,
the respective frictional connections are arranged to:
rotate the first race, in the second circumferential direction, at a second speed less than the first speed; or,
rotate the first race, in the second circumferential direction, at the first speed.
